(19) United States
(12) Patent Application Publication
(10) Pub. No.: US 2017/0213098 A1
(43) Pub. Date: Jul. 27, 2017

(54) INFORMATION ENTRY VIA IN-VEHICLE CAMERA

(71) Applicant: Panasonic Automotive Systems Company of America, Division of Panasonic Corporation of North America, Peachtree City, GA (US)

(72) Inventors: SACHIKO KOBAYASHI, NOVI, MI (US); DAVID LYON, HUNTINGTONWOODS, MI (US); GARY L. BRADDOCK, GROSSE POINTE, MI (US); NARAYANI MITAL, ROYAL OAK, MI (US); PATRICK HANSLITS, CLARKSTON, MI (US); DONALD ALLEN TURNER, LIVONIA, MI (US)

(73) Assignee: Panasonic Automotive Systems Company of America, Division of Panasonic Corporation of North America

(21) Appl. No.: 15/416,635

(22) Filed: Jan. 26, 2017

Related U.S. Application Data
(60) Provisional application No. 62/287,401, filed on Jan. 26, 2016.

(51) Int. Cl. G06K 9/32; G06K 9/00; G06F 3/00; H04N 7/18; G06F 3/01

(52) U.S. Cl. CPC G06K 9/3258; H04N 7/183; G06F 3/017; G06F 3/005; G06K 9/00832; G06K 2209/03; G06K 2209/01

(57) ABSTRACT

A vehicle includes a camera directed generally toward a driver seat of the vehicle. The camera captures images within a passenger compartment of the vehicle. A text recognition module is communicatively coupled to the camera and recognizes text characters in the captured images. An electronic processor is communicatively coupled to the text recognition module and interprets the recognized text characters as text information, categorizes the text information, and enters the text information into an application within the vehicle.

### CROSS-REFERENCED TO RELATED APPLICATIONS

This application claims benefit of U.S. Provisional Application No. 62/287,401 filed on Jan. 26, 2016, which the disclosure of which is hereby incorporated by reference in its entirety for all purposes.

### FIELD OF THE INVENTION

The disclosure relates to the field of in-vehicle information systems, and, more particularly, to data entry into an in-vehicle information system.

### BACKGROUND OF THE INVENTION

It is known to enter text information into an electronic vehicle system by typing via a keypad. However, such data entry is time consuming and requires the user's full attention such that he cannot safely perform any driving tasks while typing.

### SUMMARY

The present invention may include the use of a camera with a text recognition algorithm to perform automatic information entry into a vehicle system. The information may include vehicle destination, contact info, point of interest identification, etc. The information may be in the form of any type of text including text displayed on any hand-held devices (e.g., tablet, phone, etc.) or printed on papers, napkins, business cards, etc. The information does not need to be manually re-entered in the vehicle system, such as by typing or voice entry. Nor does the invention require any application on the devices in order to be able to transfer the information to the vehicle.

The inventive system is simple and handy because the text source of information can be displayed or printed on anything as long as the text is legible. The inventive system is also a quick and safe way of entering the info. Once the information is scanned and processed, the vehicle may ask the driver what he wants to do with the information. If the system recognizes the text as an address, the system may ask the driver if he would like to make the address a new vehicle destination or save the address for later use. If the system recognizes the text as a phone number, the system may ask the driver if he would like to call the number now or save it for later, etc. If the system recognizes the text as a restaurant name, the system may ask the driver if he would like to place a food order with the restaurant. The information can be infotainment related, such as the title of a song. In this case, the system may ask the driver if he wants the vehicle audio system to play the song.

In one embodiment, the invention comprises a vehicle including a camera directed generally toward a driver seat of the vehicle, and the camera can capture images within a passenger compartment of the vehicle. A text recognition module is communicatively coupled to the camera and recognizes text characters in the captured images. An electronic processor is communicatively coupled to the text recognition module and interprets the recognized text characters as text information and enters the text information into an application within the vehicle. The processor may also categorize the text information, e.g., recognize the information as address, phone number, POI, etc., based on the format, type, and metadata of entered text.

In another embodiment, the invention comprises a vehicle including a camera disposed adjacent to a driver's seat of the vehicle, and directed in a generally upward direction. The camera captures images within a passenger compartment of the vehicle. A substantially transparent first substrate is oriented substantially perpendicular to the generally upward direction and is disposed within a field of view of the camera. The first substrate supports a second substrate bearing text characters. A text recognition module (to interpret information entered by gesture) is communicatively coupled to the camera and recognizes text characters in the captured images. An electronic processor is communicatively coupled to the text recognition module and interprets the recognized text characters as text information and enters the text information into an application within the vehicle.

In yet another embodiment, the invention comprises a method of operating a motor vehicle, including providing a camera directed generally toward a driver seat of the vehicle, such as on the rear-view mirror or visor, for example. The camera can also be used to capture images within a passenger compartment of the vehicle. A text recognition module is communicatively coupled to the camera. The text recognition module is used to recognize text characters in the captured images. The recognized text characters are interpreted as text information, the text characters are processed to identify what the information is, and the text information is entered into an application within the vehicle.

The camera that is used for the information entry can also be used for other applications such as driver monitoring and gesture control.

The present invention has the advantage that text data may be quickly and automatically entered into a vehicle system without any effort from the driver except to show the information to the camera.

Another advantage is that the driver may safely perform at least some driving tasks while entering text data into the vehicle system.

### BRIEF DESCRIPTION OF THE DRAWINGS

A better understanding of the present invention will be had upon reference to the following description in conjunction with the accompanying drawings.

FIG. 1 is a block diagram of one embodiment of an in-vehicle information entry arrangement of the present invention.

FIG. 2 is a perspective view of one embodiment of a passenger compartment of a vehicle including the in-vehicle information entry arrangement of FIG. 1.

FIG. 3 is a perspective view of another embodiment of a passenger compartment of a vehicle including the in-vehicle information entry arrangement of FIG. 1.

FIG. 4 is a flow chart of one embodiment of a method of the present invention for operating a motor vehicle.

### DETAILED DESCRIPTION OF THE PREFERRED EMBODIMENTS

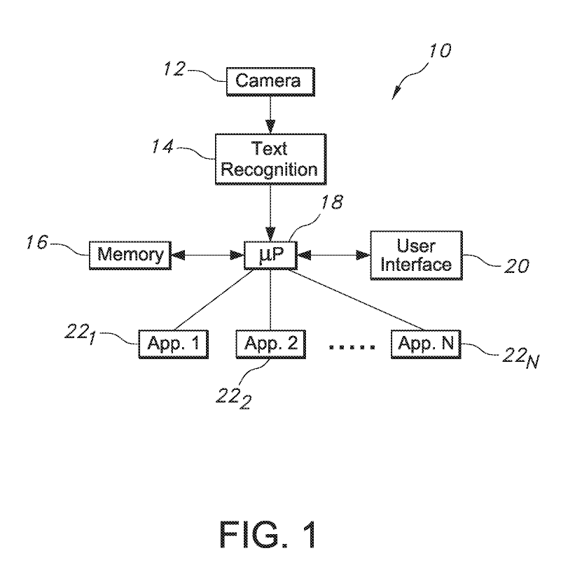

FIG. 1 illustrates one embodiment of an in-vehicle information entry arrangement 10 of the present invention including a camera 12, a text recognition module 14, a memory device 16, an electronic processor 18, a user interface 20 and applications 221, 222, . . . 22N. Camera 12 may be positioned to capture images of text within the vehicle passenger compartment that is displayed on a personal electronic device or printed on paper. Camera 12 may capture a series of images during a short period of time, such as a time period lasting approximately between one and three seconds. On the captured images, text may be “read” that is “written” or otherwise indicated by movements or swipes of a user's finger in the air or on a transparent substrate. The camera in the center console may be used for other gesture control or gesture interpretation as well, and does not have to be related to data entry.

The images captured by camera 12 may be transmitted to text recognition module 14 which may recognize the alphanumeric characters (or other written characters) in the images. Text recognition module 14 may transmit the recognized characters to processor 18, which may interpret the recognized characters as words, commands or menu selections, for example. Text recognition module 14 may also identify what kind of information the recognized characters are, such as an address, phone number, schedule/meeting info, etc.

User interface 20 may include a display screen, head up display (HUD), microphone, loudspeaker, pushbuttons, etc. Through user interface 20, processor 18 may ask the driver or other user what he would like processor 18 to do with the recognized text that he entered. For example, the driver may instruct processor 18 to store the text from a business card he held up to camera 12 in a contacts list stored in memory 16. Alternatively, the driver may ask processor 18 to use the text in conjunction with one of applications 22. For example, one application may be a mobile telephone, and the user may ask processor 18 to use the mobile telephone to call a telephone number in the text. Another application may be a navigation system, and the user may ask processor 18 to use the navigation system to plan a route to a street address in the text.

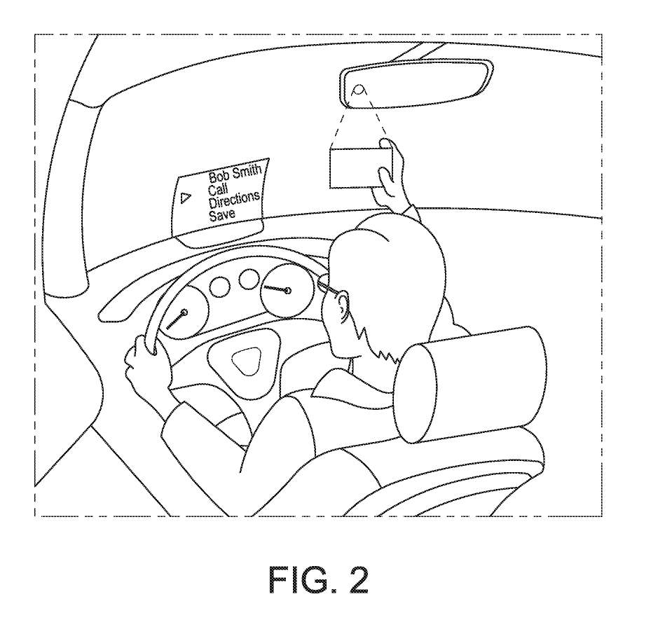

FIG. 2 illustrates one embodiment of a passenger compartment of a vehicle including the in-vehicle information entry arrangement 10. Camera 12 may be in the form of a camera mounted in the rear-view mirror within the passenger compartment. This camera, which may be used for scanning the text information, can be the same rear facing camera (or any other camera or cameras used inside vehicle) that is used for driver monitoring (including other occupant monitoring depending on the position and angle of the camera), camera-based gesture interpretation and control, or character recognition. Thus, no additional hardware components may be required to implement the inventive arrangement 10.

In the example depicted in FIG. 2, the driver is holding up a business card to the camera, and the text is recognized by arrangement 10. The head up display presents the name on the business card, Bob Smith, and a menu of options of what can be done with the text information on the card. Alternatively, the name and menu may be presented to the driver via ICS or voice response. The user can select one of the presented options by pressing a push button, by some form of writing, or by speaking. In the depicted example, the options include “call” (use a telephone to place a call to Bob Smith), “directions” (use a navigation system to determine directions to the address on the business card), and “save” (save the text on the business card in a contacts list in memory 16). Instead of a business card, the driver could hold up to the camera the display screen of a mobile phone, tablet, or even a napkin on which text characters have been handwritten. Although the driver may use the inventive system, the placement on the center console enables passengers to use the system as well.

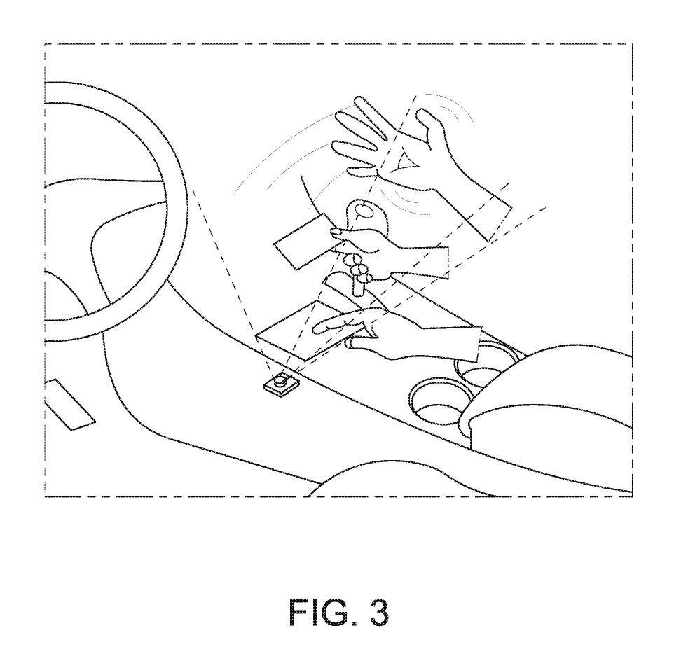

FIG. 3 illustrates another embodiment of a passenger compartment of a vehicle including the in-vehicle information entry arrangement 10. Camera 12 may be in the form of a camera mounted in the console between the driver's seat and the front passenger's seat. The camera may be directed in an upward direction toward a transparent lens or other substrate on which the driver may place a surface bearing text, or on which the driver may draw characters by swiping his finger in patterns in the form of text characters.

An upwardly direct light (not shown) may be provided adjacent to the camera. The driver may selectively operate this light if needed for the text on the lens to be discerned and recognized, such as text printed on paper, but may keep the light off in the case of the camera scanning an illuminated display, such as on a mobile phone.

The camera may function as a scanner. The text recognition module may recognize hand gestures, finger swipes, handwritten notes or destinations, business cards, and text on a mobile electronic device screen, such as text messages, emails, web pages, contact information, and infotainment information, which may be music related.

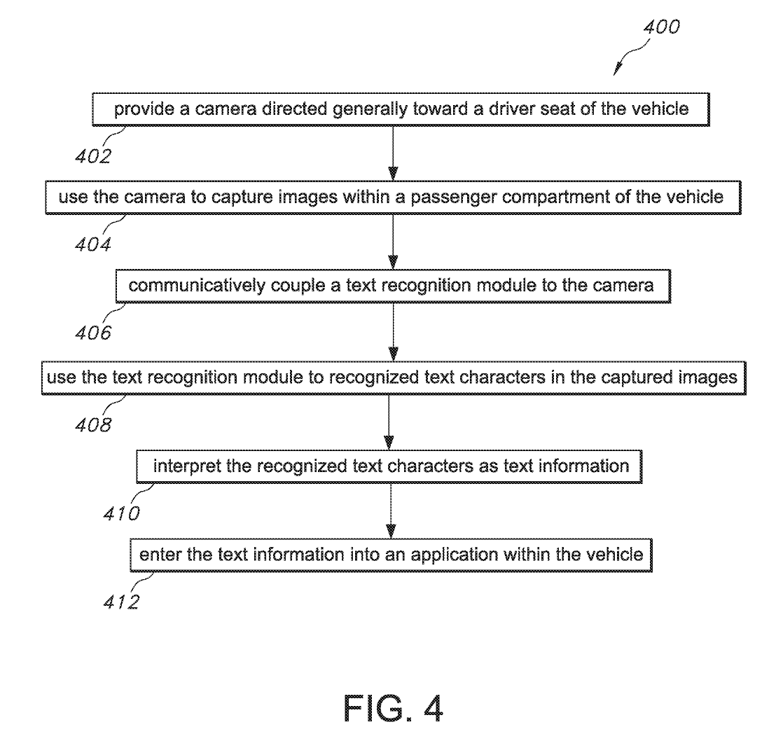

FIG. 4 illustrates one embodiment of a method 400 of the present invention for operating a motor vehicle. In a first step 402, a camera directed generally toward a driver seat of the vehicle is provided. For example, camera 12 may be mounted on a rear-view mirror, on a visor, or on a center console of a vehicle such that camera 12 is pointed toward a driver's seat of the vehicle.

Next, in step 404, the camera is used to capture images within a passenger compartment of the vehicle. For example, camera 12 may capture images of text within the vehicle passenger compartment that is displayed on a personal electronic device or printed on paper.

In a next step 406, a text recognition module is communicatively coupled to the camera. For example, the images captured by camera 12 may be transmitted to text recognition module 14 wirelessly or via a hard wire.

In step 408, the text recognition module is used to recognize text characters in the captured images. For example, text recognition module 14 may recognize the alphanumeric characters (or other written characters) in the images.

Next, in step 410, the recognized text characters are interpreted as text information. That is, text recognition module 14 may transmit the recognized characters to processor 18, which may interpret the recognized characters as words, commands or menu selections, for example.

In a final step 412, the text information is entered into an application within the vehicle. For example, the driver may ask processor 18 to use the text in conjunction with one of applications 22. One application may be a mobile telephone, and the user may ask processor 18 to use the mobile telephone to call a telephone number in the text. Another application may be a navigation system, and the user may ask processor 18 to use the navigation system to plan a route to a street address in the text.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A vehicle, comprising:
a camera directed generally toward a driver seat of the vehicle, the camera being configured to capture images within a passenger compartment of the vehicle;
a text recognition module communicatively coupled to the camera and configured to recognize text characters in the captured images; and
an electronic processor communicatively coupled to the text recognition module and configured to interpret the recognized text characters as text information and enter the text information into an application within the vehicle.

2. The vehicle of claim 1 wherein the camera is disposed in the passenger compartment of the vehicle.

3. The vehicle of claim 1 wherein the electronic processor is configured to store the text information in a memory device.

4. The vehicle of claim 1 further comprising a transparent substrate configured to support a substrate on which the text is visible while the images are captured.

5. The vehicle of claim 1 wherein the recognized text characters in the captured images are created by hand gestures by a driver of the vehicle.

6. The vehicle of claim 1 wherein the application comprises a telephone.

7. The vehicle of claim 1 wherein the application comprises a navigation system.

8. A vehicle, comprising:
a camera disposed adjacent to a driver's seat of the vehicle, and directed in a generally upward direction, the camera being configured to capture images within a passenger compartment of the vehicle;
a substantially transparent first substrate disposed within a field of view of the camera, the first substrate being configured to support a second substrate bearing text characters;
a text recognition module communicatively coupled to the camera and configured to recognize text characters in the captured images; and
an electronic processor communicatively coupled to the text recognition module and configured to interpret the recognized text characters as text information and enter the text information into an application within the vehicle.

9. The vehicle of claim 8 wherein the camera is disposed in the passenger compartment of the vehicle.

10. The vehicle of claim 8 wherein the electronic processor is configured to store the text information in a memory device.

11. The vehicle of claim 8 wherein the transparent substrate is supported by a console disposed between the driver's seat and a front passenger seat of the vehicle.

12. The vehicle of claim 8 wherein the recognized text characters in the captured images are interpreted from hand gestures performed by a driver of the vehicle.

13. The vehicle of claim 8 wherein the first substrate is oriented substantially perpendicular to the generally upward direction.

14. The vehicle of claim 8 wherein the application comprises a telephone or navigation system.

15. A method of operating a motor vehicle, said method comprising:
providing a camera directed generally toward a driver seat of the vehicle;
using the camera to capture images within a passenger compartment of the vehicle;
communicatively coupling a text recognition module to the camera;
using the text recognition module to recognize text characters in the captured images;
interpreting the recognized text characters as text information; and
entering the text information into an application within the vehicle.

16. The method of claim 15 further comprising:
storing the text information in a memory device; and
suggesting to a user a next action to be performed.

17. The method of claim 15 wherein the next action is placing a telephone call, storing the text information in a particular electronic file, or transmitting the text information outside the vehicle.

18. The method of claim 15 further comprising supporting a transparent substrate in an orientation substantially perpendicular to the direction in which the camera is directed, wherein the images are captured through the substrate.

19. The method of claim 15 wherein the recognized text characters in the captured images are created by hand gestures by a driver of the vehicle.

20. The method of claim 15 wherein the application comprises a telephone or navigation system.
